(19) United States
(12) Patent Application Publication
(10) Pub. No.: US 2008/0220917 A1
(43) Pub. Date: Sep. 11, 2008

(54) Belt-driven conical-pulley transmission with hydraulic system and auxiliary oil source

(75) Inventors: Marco Grethel, Buhlertal (DE); Eric Muller, Kaiserslautern (DE); Reinhard Stehr, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/072,299

(22) Filed: Feb. 25, 2008

Related U.S. Application Data
(60) Provisional application No. 60/903,281, filed on Feb. 23, 2007.
(60) Provisional application No. 60/936,539, filed on Jun. 21, 2007.

(51) Int. Cl. F16H 61/662

(52) U.S. Cl. 474/28

(57) ABSTRACT

A belt-driven conical-pulley transmission contained in the power train of a motor vehicle and having two conical disk pairs encircled by an endless torque-transmitting element. A hydraulic system is provided for pressing the conical surfaces of the conical disks against the endless torque-transmitting means and for opposite adjustment of the spacing between the conical disks for an adjustment of the transmission ratio. The hydraulic system includes a pump driven by an internal combustion engine that propels the vehicle, and the system includes an auxiliary oil source with which a predetermined minimum pressure is maintained in the hydraulic system when the internal combustion engine is shut off.

### BACKGROUND OF THE INVENTION

1. Field of the Invention

The present invention relates to a belt-driven conical-pulley transmission contained in the power train of a motor vehicle and having two conical disk pairs encircled by an endless torque-transmitting means. A hydraulic system is provided for pressing the conical surfaces of the conical disks against the endless torque-transmitting means, and for opposite adjustment of the spacings of the conical disks of the disk pairs for adjusting the transmission ratio, which hydraulic system includes a pump driven by an internal combustion engine to propel the vehicle.

2. Description of the Related Art

FIG. 2 shows part of a known belt-driven conical-pulley transmission, namely the driven or input side of the belt-driven conical-pulley transmission, designated in its entirety by reference numeral 1, and which is driven by an internal combustion engine (not shown). In a fully implemented belt-driven conical-pulley transmission, connected to the input-side part shown there is a complementarily designed output-side part of the continuously variable belt-driven conical-pulley transmission, the two parts being connected by an endless torque-transmitting means in the form of a plate link chain 2, for example, for transmitting torque. The belt-driven conical-pulley transmission input side 1 includes an input shaft 3 that in the illustrated exemplary embodiment is integrally formed with a stationary conical disk or fixed disk 4. The axially fixed conical disk 4 is positioned in the axial longitudinal direction of shaft 3 close to and opposite an axially repositionable conical disk or movable disk 5.

The torque produced by the internal combustion engine is introduced through a gear 6 supported on the shaft 3 by a roller bearing in the form of a ball bearing 7 that absorbs axial and radial forces, and which is axially fixed on the shaft 3. Between gear 6 and axially movable conical disk 5 is a torque sensor 10 which has an axially fixed cam disk 11 that bears against a likewise axially fixed support ring 12 and interacts with a formed surface 14′, formed on a sensor piston 14, through rolling elements in the form of balls 13. Torque sensor 10 also includes a pressure chamber 15, which is bounded by shaft 3, movable disk 5, support ring 12, and sensor piston 14. Sensor piston 14 follows the axial motion of the balls 13. Its position thus depends upon the input torque.

A supply bore 16, which is chargeable with hydraulic fluid through a central axial bore 18 in shaft 3, issues into pressure chamber 15. In the illustrated underdrive position of the disk pair, the outlet of supply bore 16 is largely closed by the left edge of a flange 20 of movable disk 5. Also issuing into pressure chamber 15 is a discharge bore 22, which leads into an axial discharge channel 24 of shaft 3. The effective open cross-section area of discharge bore 22 is influenced by the position of sensor piston 14. Overall, in the described system the force exerted on the movable disk 5 can be changed in a known way, depending upon the input torque and the transmission ratio.

In the condition illustrated in FIG. 2, movable disk 5 is at its most distant position from the fixed disk, i.e., the transmission is in underdrive.

Movable disk 5 is repositioned by an additional pressure chamber 26, which is formed between support ring 12 and an annular piston 28 attached to movable disk 5 and is supplied with hydraulic fluid via connecting channels 30 that lead through movable disk 5 from a annular chamber 32. Annular chamber 32 is formed between a recess in the inner surface of movable disk 5 or its flange 20, and the outer circumferential surface of shaft 3. Within annular chamber 32 are the axial teeth 34, through which movable disk 5 is engaged with shaft 3 in a rotationally fixed but axially movable engagement. A connecting bore 36 formed in shaft 3 issues into annular chamber 32 through which annular chamber 32 and thus pressure chamber 26 can be subjected to control pressure that can be fed to an axial bore 38 in shaft 3, which is in the form of a blind bore 38. The control pressure applied to axial bore 38 to adjust the transmission ratio is controlled in a known manner by a control device that subjects movable disk 5 to an adjusting pressure that depends upon the operating conditions of the vehicle, and is in addition to the pressure that is present in the pressure chamber 15, which is a function of the input torque.

Hydraulic pressure is supplied to axial bore 18 and to axial bore 38, and, if necessary, to a forward and a reverse clutch (not shown) and additional components, by a hydraulic system that includes as its pressure source a pump that is driven by the internal combustion engine, which also propels the vehicle in which the belt-driven conical-pulley transmission is provided.

Fuel consumption has recently become increasingly important. This has led to the development of stop/start systems, in which the internal combustion engine is shut off automatically when it is not needed for propulsion, for example when stopped at a traffic light or when the vehicle is decelerating. Such stop/start systems, which can also be integrated into hybrid drives in which the vehicle can be optionally driven by the internal combustion engine or by an electric motor, or else by both motors together, are only acceptable in practical driving operation if the internal combustion engine starts very quickly when needed, i.e., when an accelerator pedal is operated, for example, and the power train is immediately available again for propelling the vehicle.

As the description of FIG. 2 makes clear, hydraulic fluid is constantly flowing through the pressure chamber 15, with the volumetric flow, and hence the pressure in pressure chamber 15, being determined by the cross-sectional area of the outlet from pressure chamber 15 into discharge bore 22 determined by the axial position of sensor piston 14.

If no more hydraulic fluid is being transported into the bores 18 und 38, if the pump is stopped because the internal combustion engine is stopped, there is a danger that pressure chamber 15 will partially drain, so that the transmission must first be filled completely with hydraulic fluid before it is ready to function again after a start-up of the internal combustion engine. That delay between the full functional readiness of the transmission and the start-up of the internal combustion engine leads to problems in stop/start systems, in which the internal combustion engine is brought to action very quickly by an electrical machine, which can operate as a generator and a motor if necessary.

An object of the present invention is to further develop a belt-driven conical-pulley transmission of the type described above, and in such a way that it is suitable for stop/start systems and is immediately fully functional when the internal combustion engine is restarted after having been stopped.

### SUMMARY OF THE INVENTION

This problem is solved with the features of claim 1.

The subordinate claims are directed at advantageous embodiments and refinements of the belt-driven conical-pulley transmission according to the invention.

Briefly stated, in accordance with one aspect of the present invention, a belt-driven conical-pulley transmission contained in the power train of a vehicle and having two conical disk pairs encircled by an endless torque-transmitting means, and a hydraulic system for pressing the conical surfaces of the conical disks against the endless torque-transmitting means and for opposite adjustment of the spacings between the conical disks for adjusting the transmission ratio, wherein the hydraulic system includes a primary pump driven by an internal combustion engine that propels the vehicle, the hydraulic system includes an auxiliary oil source with which a predetermined minimum pressure is maintained in the hydraulic system when the internal combustion engine is shut off. The auxiliary oil source transports the same hydraulic fluid that is transported by the primary pump that is driven by the internal combustion engine.

Advantageously, the auxiliary oil source is an auxiliary pump driven by an electric motor.

An auxiliary supply line pressurized by the auxiliary oil source preferably issues into a supply line pressurized by the primary pump.

It is also advantageous if the auxiliary supply line is situated in the supply line upstream from valves that modulate the oil flow delivered by the primary pump to control the belt-driven conical-pulley transmission and/or a forward clutch and/or a reverse clutch.

In order for the hydraulic fluid delivered from the auxiliary oil source to be used efficiently, a flow check device can be provided in the auxiliary supply line to prevent a flow of hydraulic fluid from the primary supply line to flow through the outlet of the auxiliary supply line in the direction of the auxiliary pump.

The flow check device is also provided in the auxiliary supply line to prevent hydraulic fluid delivered by the primary pump from flowing through the outlet of the auxiliary supply line and into the auxiliary supply line in the direction of the auxiliary oil source.

In order not to design the auxiliary oil source unnecessarily large, the hydraulic system advantageously adopts a condition with small leakage flows when the auxiliary oil source is actuated.

The predetermined minimum pressure maintained by the auxiliary oil source is such that the belt-driven conical-pulley transmission is immediately fully functional when the primary pump is again driven after an interruption.

When the internal combustion engine is stopped the auxiliary oil source can be actuated as the result of the actuation of a stop/start device in the power train, for example.

Advantageously, as the result of the actuation of a stop/start device in the power train, when the internal combustion engine is stopped the hydraulic oil source is actuated shortly before the internal combustion engine is restarted.

### BRIEF DESCRIPTION OF THE DRAWINGS

The structure, operation, and advantages of the present invention will become further apparent upon consideration of the following description taken in conjunction with the accompanying drawings, in which:

FIG. 1 is a circuit diagram of a hydraulic system for a belt-driven conical-pulley transmission with clutches and that includes an auxiliary pump in accordance with an embodiment of the present invention; and

FIG. 2 is a longitudinal section through a part of a known belt-driven conical-pulley transmission.

### DESCRIPTION OF THE PREFERRED EMBODIMENTS

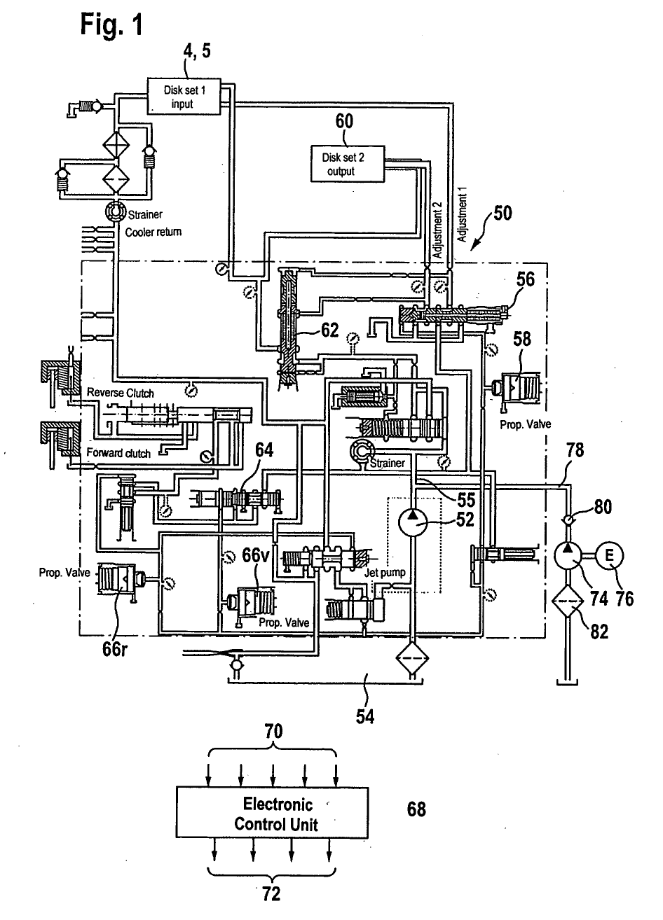

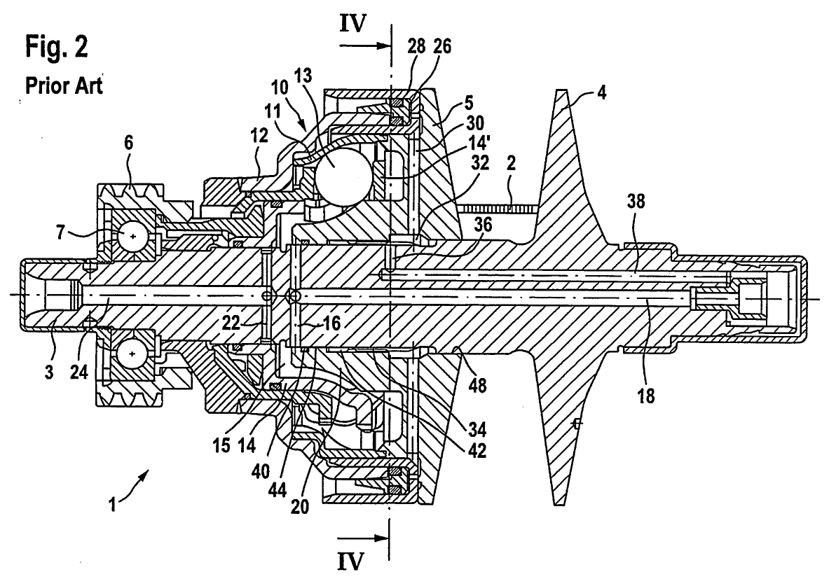

FIG. 1 shows a hydraulic system, designated in the aggregate as 50, for supplying hydraulic fluid to the belt-driven conical-pulley transmission shown in FIG. 2. Hydraulic system 50 includes a primary pump 52 that is driven by an internal combustion engine (not shown) which draws hydraulic fluid from a hydraulic fluid or liquid reservoir 54 and delivers it under pressure into a primary supply line 55. The pressure in the axial bore 38 of FIG. 2 that leads to the pressure chamber 26 of an input disk pair 4, 5, and the pressure in a corresponding pressure chamber of an output disk pair 60, is controlled by way of a hydraulic transmission ratio adjusting valve 56 the is actuated by an electrically actuated transmission ratio control valve 58. The system pressure in the hydraulic system is controlled by way of a hydraulic regulating valve 62. In addition, a clutch valve 64 that is controlled by an electronically actuated clutch control valve 66v is supplied with hydraulic pressure by the primary pump 52.

To control the valves 58 and 66 an electronic control unit 68 is provided and includes a microprocessor and a program and data memory, whose inputs 70 are connected to sensors or other control devices and receive relevant data from the power train for operation of the valves. Outputs 72 of the electronic control unit 68 are connected to the control valves 58 and 66 and, if necessary, to other electrically controlled components of the power train, which is not illustrated in detail.

Other valves and details of the hydraulic system 50 and of the electronic control device 68 are not further explained, since their construction is known.

In accordance with the present invention, in addition to primary pump 52 an auxiliary pump 74 is provided, which preferably delivers hydraulic fluid from the same hydraulic fluid reservoir 54 as primary pump 52. Auxiliary pump 74 is rotatably driven by an electric motor 76 that is connected to one of the outputs 72 of electronic control unit 68. Auxiliary pump 74 delivers hydraulic fluid into an auxiliary supply line 78, which issues into primary supply line 55 upstream from primary pump 52 and represents an auxiliary oil source.

A check valve 80 is positioned between auxiliary pump 74 and the outlet of auxiliary supply line 78 into primary supply line 55, to prevent hydraulic fluid from flowing from the outlet through auxiliary supply line 78 to auxiliary pump 74.

The function of auxiliary pump 74 is as follows:

When electronic control unit 68 receives a signal through inputs 70 reporting stopping of the internal combustion engine (not shown), which drives the gear 6 (FIG. 2) of the belt-driven conical-pulley transmission and the primary pump 52, a drive clutch (not shown) between the internal combustion engine and the gear 6 is disengaged, and the primary pump 52 stops. Auxiliary pump 74 is rotatably driven by activating electric motor 76, and it delivers hydraulic fluid through the auxiliary supply line 78 into the primary supply line 55. If primary pump 52 is a vane pump with a cold start device, primary pump 52 takes over the function of a check valve, so that no hydraulic fluid delivered by auxiliary pump 74 flows through pump 62 into the hydraulic fluid reservoir 54.

The delivery capacity of auxiliary pump 74 is matched to the system so that in a stop mode, i.e., when primary pump 52 is stopped, the vehicle is ensured to be ready to travel as quickly as possible upon restart, i.e., at the inception of operation of primary pump 52. To that end, the pressure chamber 15 of torque sensor 10 (see FIG. 2) must be supplied with a certain minimum volume of hydraulic fluid, for example a volumetric flow of 0.5 liters per minute. It is also advantageous if the individual components of the belt-driven conical-pulley transmission are brought by appropriate actuation of the valves into a position in which only small leakage flows develop. To that end, the transmission ratio control valve 58 is brought to a middle position by appropriate application of 600 mA, for example, the clutch control valve 66v is adjusted by application of 250 mA, for example, so that a forward creep of the transmission is set. A cooling oil control valve 66r is adjusted by appropriate application of 600 mA, for example, to a level at which sufficient cooling occurs.

If primary pump 52 is not suitable for preventing a backflow of the hydraulic fluid into the hydraulic fluid reservoir 54, a check valve similar to check valve 80 can be provided upstream or downstream from primary pump 52.

The outlet of auxiliary supply line 78 into supply line 55 is advantageously located directly downstream from primary pump 52, i.e., between primary pump 52 and the valves supplied by primary pump 52, for example the clutch valve 64, a pilot pressure valve, the transmission ratio adjusting valve 58, or the hydraulic regulating valve 62.

The described system can be modified in many ways. For example, the auxiliary pump 74 can be replaced by a pressure storage device that is charged when primary pump 52 is in operation, and that has sufficient volume so that the supply of pressure to the transmission—with appropriately low leakage flows—is ensured for a sufficiently long time period during stopped operation. The leakage flows can be reduced intentionally by positioning electrically actuated shut-off valves in the respective leakage pipes. Transmission 1 does not necessarily require two pressure chambers arranged in each disk pair.

Filtering can take place on the suction side of auxiliary pump 74 by means of a filter 82, for example, having a close-mesh wire screen with a mesh size of 100 μm, for example. An additional screen or filter of similar mesh size can be provided on the pressure side of auxiliary pump 74.

All-in-all, the present invention permits CVT transmissions to be provided, for example belt-driven conical-pulley transmissions that are controlled hydraulically and that require a particular minimum hydraulic system pressure to be maintained in order to be ready for operation immediately, with stop/start devices that enable electronic shut-off and quick re-starting of an internal combustion engine in order to save fuel.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A belt-driven conical-pulley transmission for a power train of a motor vehicle, said transmission comprising:
two pairs of conical disks encircled by an endless torque-transmitting means and including a hydraulic system for pressing conical surfaces of the conical disks against the endless torque-transmitting means and for opposite adjustment of spacings between the conical disks for an adjustment of a transmission ratio,
wherein the hydraulic system includes a primary pump driven by an internal combustion engine propelling the vehicle, and
wherein the hydraulic system includes an auxiliary source of pressurized hydraulic fluid with which a predetermined minimum pressure is maintained in the hydraulic system of the transmission when the internal combustion engine is shut off.

2. A belt-driven conical pulley transmission in accordance with claim 1, wherein the auxiliary source of pressurized hydraulic fluid is an auxiliary pump that is driven by an electric motor.

3. A belt-driven conical-pulley transmission in accordance with claim 2, wherein an auxiliary hydraulic fluid supply line that is pressurized by the auxiliary source of pressurized hydraulic fluid is connected with a primary hydraulic fluid supply line that is pressurized by the primary pump during engine operation.

4. A belt-driven conical pulley transmission in accordance with claim 3, wherein the auxiliary hydraulic fluid supply line is connected to the primary hydraulic fluid supply line at a point upstream from valves that modulate a pressure delivered by the primary pump to control at least one of the belt-driven conical-pulley transmission, a forward clutch, and a reverse clutch.

5. A belt-driven conical-pulley transmission in accordance with claim 3, wherein a flow check device is provided in the auxiliary hydraulic fluid supply line to prevent hydraulic fluid delivered from the primary pump from flowing from the outlet of the auxiliary hydraulic fluid supply line into the auxiliary hydraulic fluid supply line to the auxiliary pump.

6. A belt-driven conical-pulley transmission in accordance with claim 3, wherein a flow check device is provided in the auxiliary hydraulic fluid supply line to prevent hydraulic fluid delivered by the primary pump from flowing from the outlet of the auxiliary hydraulic fluid supply line into the auxiliary hydraulic fluid supply line in the direction of the auxiliary source of pressurized hydraulic fluid.

7. A belt-driven conical-pulley transmission in accordance with claim 1, wherein the hydraulic system is in a condition with small leakage flows when the auxiliary source of pressurized hydraulic fluid is actuated.

8. A belt-driven conical-pulley transmission in accordance with claim 1, wherein the predetermined minimum pressure maintained by the auxiliary source of pressurized hydraulic fluid is of a sufficient pressure level such that the belt-driven conical-pulley transmission is immediately fully functional when the primary pump is driven again after an interruption in its operation.

9. A belt-driven conical-pulley transmission in accordance with claim 1, wherein the auxiliary source of pressurized hydraulic fluid is actuated when the internal combustion engine is stopped as a result of actuation of a stop/start device in the power train.

10. A belt-driven conical-pulley transmission in accordance with claim 1, wherein when the internal combustion engine is stopped as the result of actuation of a stop/start device in the power train, the auxiliary source of pressurized hydraulic fluid is actuated shortly before the internal combustion engine is restarted.
